(19) United States
(12) Patent Application Publication
(10) Pub. No.: US 2007/0046570 A1
(43) Pub. Date: Mar. 1, 2007

(54) WRITE-IN DRIVING METHOD FOR PLASMA DISPLAY

(76) Inventor: Chao-Hung Hsu, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,290

(22) Filed: Sep. 6, 2005

(30) Foreign Application Priority Data
Aug. 31, 2005 (TW) 94129923

(51) Int. Cl. G09G 3/28

(52) U.S. Cl. 345/60

(57) ABSTRACT

An addressing driving method for a plasma display is described. The plasma display comprises at least a scan line and at least a common electrode. The addressing driving method uses the following driving scheme. Initially the plasma display is in a reset period, a scanning voltage is used to drive the scan line to equalize the wall charge distribution in cell. When the plasma display is in an addressing period, a time-varying common voltage is applied to the common electrode. Finally, the plasma display is in a sustain period, the display cells are sustained in discharge condition. The driving scheme not only discharge lag for high speed addressing but the voltage margin of the panel voltage is also increased.

### CROSS-REFERENCE TO RELATED APPLICATION

This application claims the priority benefit of Taiwan application serial no. 94129923, filed on Aug. 31, 2005. All disclosure of the Taiwan application is incorporated herein by reference.

### BACKGROUND OF THE INVENTION

1. Field of the Invention

The present invention relates to a write-in driving method for a plasma display. More particularly, the present invention relates to a plasma display having a write-in driving method that changes the common voltage applied to the common electrode with time when the plasma display is in an addressing cycle.

2. Description of the Related Art

For an AC-PDP, the displaying principle is to apply a voltage at the grid point (cell) between an X-axis electrode and a Y-axis electrode. When the applied voltage is at the gas breakdown voltage (for example, about 180 volts), gaseous atoms will be ionized to produce ions. Thereafter, electrons accelerated to a high speed through the high electric field will bombard surrounding inert gas molecules and excite their electron energy level. When electrons of the excited inert gas molecules return from a high energy level back to a base energy state, ultraviolet rays are produced. The ultraviolet rays will activate the fluorescent material coated within the discharging space. Through a specified fluorescent material having an emission spectrum within the visible range, visible light is produced. The electrode surface of the AC-PDP is covered with a dielectric material. After inputting the AC voltage with opposite polarity, the wall surface attract some electrons and ions, and therefore has the memory function.

FIG. 5 is a diagram showing the write-in driving voltage waveform of conventional plasma display described in U.S. Pat. No. 6,633,268. In a conventional reset discharge, through a high voltage VR pulse (a rectangular reset pulse 500) that reaches 300 volts applied to the entire ‘X’ electrode and through the discharge from the entire discharge space, a wall of electric charges is produced. Meanwhile, the voltage Va pulse 514 is applied to the ‘A’ electrode in synchrony with the rectangular reset pulse 500.

When the rectangular reset pulse 500 drops off, self-erase discharge is produced and neutralizes the electron and ions, attracted on the dielectric layer. Hence, the entire grid cell is transformed into a homogeneous state. In other words, wall charges are non-existent and the entire grid cell is homogenized.

In the next addressing cycle, before the scan pulse 512, a preset pulse 510 is applied to the ‘Y’ electrode. The voltage of the preset pulse 510 is −Ve and has a magnitude greater than the quantity of the negative voltage level 506 (−Vy). The bias of the voltage Vxa is applied to the ‘X’ electrode. The voltage (Vxa+Ve) between the ‘X’ and the ‘Y’ electrode is a voltage greater than the discharge breakdown voltage determined by the wall charges resulted from the rectangular reset operation.

Therefore, when the impulsive period of the preset pulse 510 is very large, there is a discharge between the ‘X’ electrode and the ‘Y’ electrode. However, because the pulse width of the preset pulse 510 is a narrow (0.3-0.5 μs), discharge will not obviously occur. Hence, during the preset pulse 510, there is a little growth in the spatial electric charges.

In the conventional technique, the greater number of preset pulses 510, the growth of the spatial charges will be more intermittent. Yet, if the number of preset pulses 510 is too many, then the preset pulse triggered electric discharge may lead to the formation of a wall of electric charges.

In the scan pulse 512 after the conventional preset pulse 510, the voltage is −Vy and this voltage alone will not trigger a discharge. However, if the voltage Va having an address pulse 518 is applied to the ‘A’ electrode, a discharge between the ‘A’ electrode and the ‘Y’ electrode is triggered. In the electric discharge between the ‘A’ electrode and the ‘Y’ electrode, because spatial electric charges have already grown through the application of the preset pulse 510, the discharge will more easily occur.

In addition, the discharge between the ‘A’ electrode and the ‘Y’ electrode triggers the discharge between the ‘X’ electrode and the ‘Y’ electrode and forms wall electric charges. After the address cycle, there is a maintaining discharge cycle. The maintaining pulses 508 and 504 of the voltage Vs are alternately applied to the ‘X’ electrode and the ‘Y’ electrode. Only the light emitting unit having wall electric charges and generating address discharge during the address cycle is discharged by the maintaining pulses 508 and 504, so as to emit the visible light.

In brief, the narrow wave of higher voltage is increased before each scan line to reduce the discharge delay period of the main addressing and hence the scanning period in U.S. Pat. No. 6,633,268. However, its circuit design is quite complicated.

### SUMMARY OF THE INVENTION

Accordingly, at least one objective of the present invention is to provide a write-in driving method for a plasma display that utilizes the application of time varying common voltage to a common electrode to increase the voltage for starting a discharge and hence reduce the delay time for producing a discharge.

At least a second objective of the present invention is to provide a write-in driving method for a plasma display that utilizes the application of time varying common voltage to a common electrode to maintain the quantity of wall electric charges in the common electrode and hence increases the range of the operating voltage.

To achieve these and other advantages and in accordance with the purpose of the invention, as embodied and broadly described herein, the invention provides a write-in driving method for a plasma display. The plasma display comprises at least a scan line and at least a common electrode. The write-in driving method uses the following schedules. At the initial stage, the plasma display is in a reset cycle, a reset voltage is used to drive the scan line, so as to normalize the charge distribution on the inner wall of the light emitting device. And then, an address discharge occurs between the scan line and an address electrode. A time-varying common voltage is applied to the common electrode to perform addressing. Thereafter, when the plasma display is in a maintaining discharge cycle, the plasma display is maintained in discharge.

According to one preferred embodiment of the present invention, the time-varying common voltage is a gradually increasing linear voltage.

According to one preferred embodiment of the present invention, the time-varying common voltage is a gradually increasing non-linear voltage.

The present invention also provides an alternative write-in driving method for a plasma display. The plasma display comprises at least a scan line and at least a common electrode. The write-in driving method uses the following schedules. When the plasma display is in a reset cycle, a reset voltage is used to drive the scan line. When the plasma display is in an addressing cycle, a time-varying common voltage is applied to increase the quantity of wall electric charges in the common electrode. Thereafter, the display device is shifted to a maintaining discharge cycle to maintain discharge.

According to the preferred embodiment of the present invention, the step of using the time-varying common voltage to increase the accumulated quantity of wall electric charges in the common electrode includes applying the time-varying common voltage to the common electrode.

In the present invention, a time-varying common voltage is applied to the common electrode. Hence, the delay time in the discharge is reduced, and the range of the operating voltage is also increased.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow diagram showing the steps in a write-in driving method for operating plasma display according to one preferred embodiment of the present invention.

FIG. 2A is a diagram showing the write-in driving voltage waveform for operating a plasma device according to one preferred embodiment of the present invention.

FIG. 2B is a diagram showing the write-in driving voltage waveform for operating another plasma device according to one preferred embodiment of the present invention.

FIG. 3 is a diagram, schematically showing the distribution of the wall electric charges and address discharge for the first few scan lines at the addressing cycle, according to one preferred embodiment of the present invention.

FIG. 4 is a diagram, schematically showing the distribution of the wall electric charges and address discharge for the last few scan lines at the addressing cycle, according to one preferred embodiment of the present invention.

FIG. 5 is a diagram showing the write-in driving voltage waveform of conventional plasma display.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

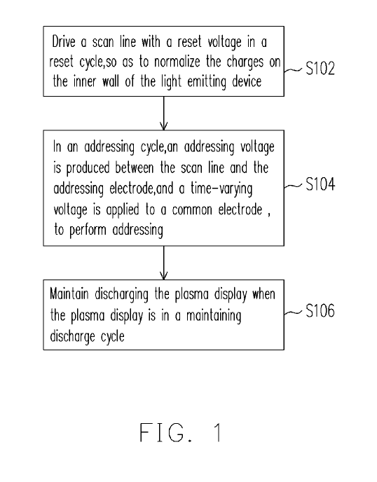

FIG. 1 is a flow diagram showing the steps in a write-in driving method for operating plasma display according to one preferred embodiment of the present invention. It should be known by anyone familiar with the technique that the plasma display might comprise a plurality of scan lines and at least a common electrode. However, this should by no means limit the scope of the present invention.

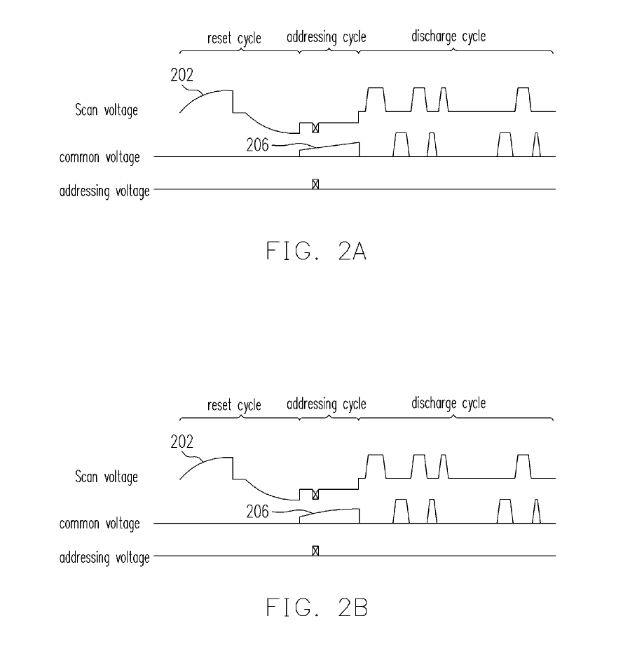

In the following description, refer to FIGS. 1, 2A and 2B. FIG. 2A is a diagram showing the write-in driving voltage waveform for operating a plasma device according to one preferred embodiment of the present invention. FIG. 2B is a diagram showing the write-in driving voltage waveform for operating another plasma device according to one preferred embodiment of the present invention.

In the present embodiment, the write-in driving method of the plasma display includes driving the scan line with a reset voltage 202 when the plasma display is in a reset cycle so that the charges on the inner wall of the light emitting device are at a normalized state (s102). The waveform of the reset voltage is the waveform 202 shown in FIGS. 2A and 2B.

After the charges on the inner wall of the light emitting device are at a normalized state, the driving waveform of the plasma display enters the address cycle and starts the addressing operation on the scan line. In the present embodiment, in the address cycle, the waveform 208 and 210 are produced between the scan line and the addressing electrode, and a time-varying common voltage is applied to the common electrode (s104) during the addressing cycle. Anyone familiar with the technique may notice that the time-varying common voltage is the waveform 204 shown in FIG. 2A, which is a fixed-slope steady rising linear voltage or the waveform 206 shown in FIG. 2B, which is a rising non-linear voltage. However, the shape of the waveform is not limited as such.

After the scan-line driving circuit has performed the scan line addressing operation, the plasma display enters a maintaining discharge cycle and the light emitting device at the maintaining address is continuously discharging. (s106).

In the preferred embodiment of the present invention, the method of accelerating the addressing time within the addressing cycle of the plasma display includes increasing the voltage for triggering discharge.

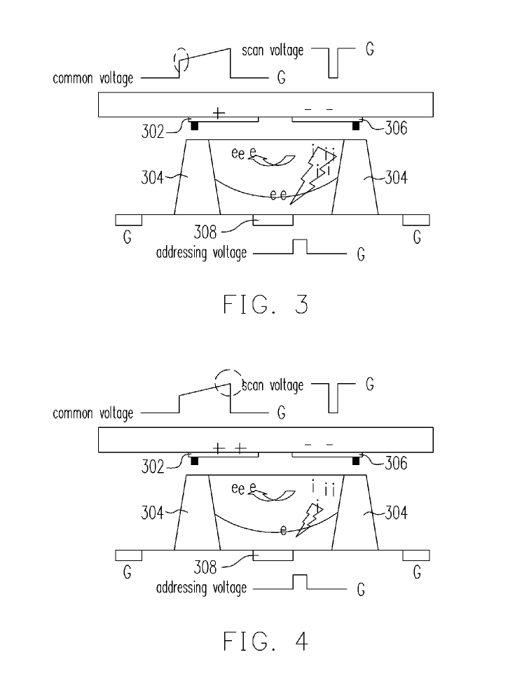

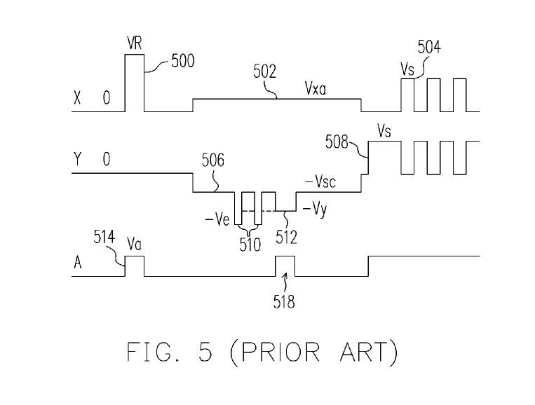

FIGS. 3 and 4 are diagrams showing the quantity of wall electric charges in a common electrode during an addressing cycle according to one preferred embodiment of the present invention. In FIGS. 3 and 4, the common electrode is labeled 302, the grid cell barrier wall is labeled 304, the scanning electrode is labeled 306, the address electrode is labeled 308, and the ground for the address electrode is labeled G. In FIG. 3, the quantity of wall electric charges in the common electrode 302 for the first few scan lines in the addressing cycle is shown. In FIG. 4, the quantity of wall electric charges in the common electrode 302 for the last few scan lines in the addressing cycle is shown.

In the present embodiment, as shown in step s104 of FIG. 1, the time-varying common voltage is applied to the common electrode 302. In FIG. 3, during the scan cycle, because the number of the high energy particles in discharge caused by the reset waveform is relative larger, the address discharge can occur under the usual common voltage, so as to achieve the intended wall charge distribution for addressing.

In FIG. 4, during the scan cycle, for the latter addressed in last few scan lines, since the high energy particles almost disappear due to a longer time from the reset waveform, the common electrode needs to be applied with a higher voltage for achieving the intended wall charge distribution for addressing, as shown in FIG. 4.

In the preferred embodiment of the present invention, due to the application of a time-increasing common voltage to the common electrode during the addressing cycle, the time required to perform the addressing operation is reduced.

In the meantime, the application of a time-varying common voltage to the common electrode during the addressing cycle also reduce the difference in operating voltage in the later addressed grid cell due to the reduction of high-energy particles with addressing time because of the priority of addressing time.

In summary, the write-in driving method of the present invention utilizes a time-varying common voltage on the common electrode can reduce the delay time in the discharge, and increase the operating range of the voltage.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A write-in driving method for a plasma display having at least a scan line and at least a common electrode, comprising the steps of:
driving the scan line with a reset voltage in a reset cycle, for normalizing wall charges on a light emitting cell;
applying a time-varying common voltage to the common electrode in an addressing cycle to perform address, wherein an address discharge occurs between the scan line and an address electrode; and
maintaining discharge for the plasma display when the plasma display is in a maintaining discharge cycle.

2. The write-in driving method of claim 1, wherein the time-varying common voltage is a gradually increasing linear voltage.

3. The write-in driving method of claim 1, wherein the time-varying common voltage is a gradually increasing non-linear voltage.

4. A write-in driving method for a plasma display having at least a scan line and at least a common electrode, comprising the steps of:
driving the scan line with a reset voltage in a reset cycle, for normalizing wall charges on a light emitting device cell;
in an address cycle, applying a time-varying common voltage to increase an discharging intensity on the common electrode and increase a quantity of the wall charges, wherein an address discharge occurs between the scan line and an address electrode; and
setting the plasma display to a maintaining discharge cycle and maintaining discharge for the addressed light emitting device cell.

5. The write-in driving method of claim 4, wherein the step of applying the time-varying common voltage to increase the discharge intensity on the common electrode comprises applying the time-varying common voltage to the common electrode.

6. The write-in driving method of claim 5, wherein the time-varying common voltage is a gradually increasing linear voltage.

7. The write-in driving method of claim 5, wherein the time-varying common voltage is a gradually increasing non-linear voltage.
